(19) United States
(12) Patent Application Publication
(10) Pub. No.: US 2026/0310695 A1
(43) Pub. Date: Oct. 8, 2026

(54) SYSTEMS AND METHODS FOR PROACTIVE RESPONSE GENERATION IN MULTI-USER SESSIONS

(71) Applicant: Panasonic Well LLC, Palo Alto, CA (US)

(72) Inventors: David Justus, Brooklyn, NY (US); Sandy Anuras, Seattle, WA (US); Katlyn Bren Johnson, Palo Alto, CA (US); Julie Black, Palo Alto, CA (US); Matthew Chester, Palo Alto, CA (US)

(21) Appl. No.: 19/339,579

(22) Filed: Sep. 25, 2025

Related U.S. Application Data
(60) Provisional application No. 63/783,555, filed on Apr. 4, 2025.

(51) Int. Cl. G06F 16/3329; G06F 16/353; G06F 40/279; H04L 51/02

(52) U.S. Cl. CPC G06F 16/33295; G06F 16/353; G06F 40/279; H04L 51/02

(57) ABSTRACT

Embodiments relate to a computer-implemented method including receiving an instruction message for an automated agent to enter a processing state. The method may include analyzing the instruction message to detect that a task is to be performed. Analyzing the instruction message may include determining that performing the task requires additional information. Determining includes classifying the automated agent in a standby state. The method may include generating a survey message in the real-time chat interface to request additional information from the set of users. The method may also include processing responses from the set of users to the survey message in the real-time chat interface. The method may further include adding a task message to the real-time chat interface. The method may not include a request from the set of users to perform the task using the additional information, thereby improving efficiency of the real-time chat interface.

### CROSS-REFERENCES TO RELATED APPLICATIONS

The present application claims the benefit of U.S. Provisional Application 63/783,555 filed Apr. 4, 2025 and is related to U.S. Non-Provisional Application entitled “AI AGENT PLATFORMS” filed Sep. 25, 2025 (Attorney Docket No.: 109304-855123-009600US), U.S. Non-Provisional Application entitled “METHODS AND SYSTEMS FOR SELF-HEALING ARTIFICIAL INTELLIGENCE” filed Sep. 25, 2025 (Attorney Docket No.: 109304-854309-009700US), and U.S. Non-Provisional Application entitled “GRAPHICAL EDITOR FOR COMPLEX ARTIFICIAL INTELLIGENCE AGENT SYSTEMS” filed Sep. 25, 2025 (Attorney Docket No.: 109304-852159-009800US), each of which are incorporated herein by reference in their entireties and for all purposes.

### FIELD

The present disclosure relates to systems and methods for automatically and continuously processing communications exchanges among users to proactively and dynamically generate responses from an automated agent.

### SUMMARY

Embodiments of the present disclosure involve systems and methods for proactive response generation in multi-user sessions. One or more messages between users in a real-time chat interface may be processed, using algorithms or machine learning models, to determine a task to be performed. A module may determine that there is not enough information to perform the task. An automated agent may await further information from the users in the real-time chat interface. If users do not supply the additional information soon enough, then the automated agent may add a message to the real-time chat interface to facilitate the users providing the additional information. Once the additional information is provided, the automated agent may proactively perform the task. The automated agent may exist in a sleep state, a processing state (where the agent has a task to be performed), or a standby state (where the agent is awaiting additional information). The states may be based on set of conditions relevant to the objective of the agent. These different states assist the automated agent in determining the task, obtaining the additional information, and performing the task.

In some aspects, embodiments relate to a computer-implemented method including receiving an instruction for an automated agent to enter a processing state. The instruction may be transmitted through a real-time chat interface by a user of a set of users. The method may include analyzing the instruction to detect that a task is to be performed. Analyzing the instruction may include determining that performing the task requires additional information. Determining includes classifying the automated agent in a standby state. The method may include generating a survey message in the real-time chat interface to request additional information from the set of users. The method may also include processing responses from the set of users to the survey message in the real-time chat interface. Processing may include inputting the responses into a natural language processor to determine the additional information. The method may further include adding a task message to the real-time chat interface. Adding the task message may include classifying the automated agent in the processing state. The method may not include a request from the set of users to perform the task using the additional information, thereby improving efficiency of the real-time chat interface. Related systems and computer-readable media are described.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a user communications system proactively generates a response in accordance with at least one embodiment.

FIG. 2 shows an illustrative example of an environment in which a state classification module dynamically processes conversation data corresponding to an ongoing communications session to classify the state of an automated agent in accordance with at least one embodiment.

FIG. 3 shows an illustrative example of a process of classifying states of an automated agent in accordance with at least one embodiment.

FIG. 4 shows an illustrative example of an interface and different states for an automated agent in accordance with at least one embodiment.

FIG. 5 shows an illustrative example of an interface and different states for an automated agent in accordance with at least one embodiment.

FIG. 6 shows an illustrative example of a process flow for processing conversation data with the goal of performing tasks in accordance with at least one embodiment.

FIG. 7 shows an illustrative example of an environment in which a task detail module identifies details in accordance with at least one embodiment.

FIG. 8 shows an illustrative example of a process for classifying states of an automated agent during an ongoing communications session in accordance with at least one embodiment.

FIG. 9 shows an illustrative example of a method for improving real-time chat interface efficiency in accordance with at least one embodiment.

FIG. 10 shows an illustrative example of an environment in which communications with members are processed in accordance with at least one embodiment; and

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Embodiments of the present disclosure describe systems and methods for generating proactive responses in multi-user sessions. Algorithms or machine learning models process messages between users in a real-time chat interface to determine tasks. A module may identify insufficient information to perform the task. The automated agent waits for further information from users in the chat. If users delay in providing the additional information, the automated agent adds a message to prompt them. Once users supply the information, the automated agent may proactively perform the task. The agent transitions from a sleep state to a processing state (when performing a task) and then to a standby state (while awaiting information). These states help the agent determine tasks, gather additional information, and execute tasks efficiently.

The integration of predictive messaging capabilities within an automated agent in a chat interface significantly enhances the system's overall efficiency. By anticipating user inputs, the automated agent can preemptively generate responses, thereby reducing the processor power required to handle real-time message processing. This proactive approach minimizes the number of messages exchanged, as the automated agent can address user queries more succinctly and accurately. Consequently, the time spent in conversation may be reduced, leading to a more streamlined user experience. Furthermore, the reduction in processing demands translates to lower energy consumption, which is particularly beneficial in mobile and battery-operated devices. This efficiency not only improves the performance of the chat interface but also contributes to the sustainability of the technology by conserving energy resources.

Moreover, the predictive messaging system enhances the chat interface's efficiency by leveraging advanced algorithms to analyze conversation patterns and predict subsequent user actions. This capability allows the automated agent to prepare and deliver responses with minimal latency, thereby improving the speed and fluidity of interactions. The reduction in response time not only enhances user satisfaction but also decreases the computational load on the system, as fewer resources are needed to maintain the conversation. Additionally, by decreasing the number of redundant or unnecessary messages, the system conserves bandwidth, which is particularly advantageous in environments with limited connectivity. As an example, most conversational AI agents respond to N times to N messages, where automated agents described herein may respond N-X times, where X may be a function of the numbers of users. Overall, the predictive messaging feature represents a significant advancement in chat interface technology, offering a more efficient, responsive, and resource-conscious solution. The various improvements apply to both the real-time chat interface and communications systems.

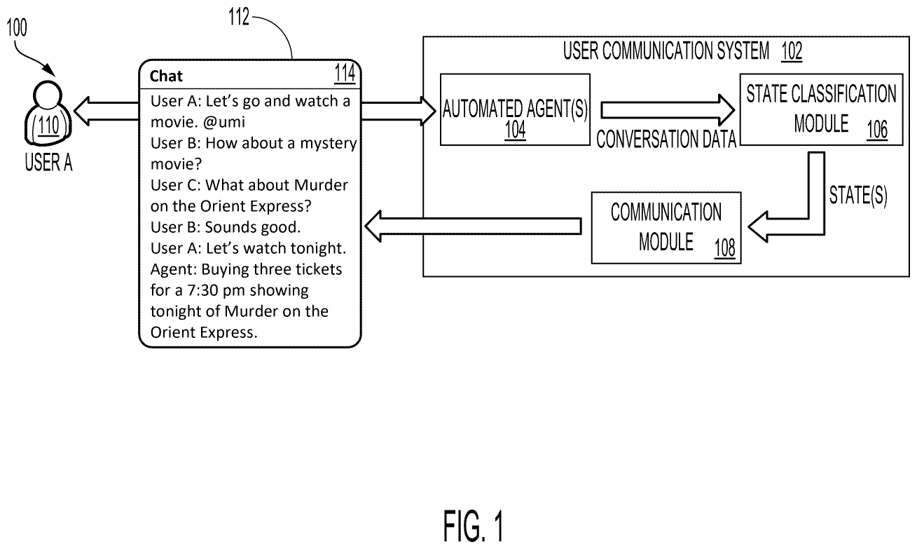

FIG. 1 shows an illustrative example of an environment 100 in which a user communications system 102 proactively and dynamically generates a response within an ongoing communications session 114. Proactively may refer to a manner that anticipates future requests, problems, needs, or changes. In the environment 100, user A 110 may be engaged in a communications session 114 with one or more other users (e.g., user B, user C). As examples, a communications session may be a group chat on SMS, an internal or external website, WhatsApp, iMessage, Facebook Messenger, Slack, or other suitable messaging platform. Automated agent(s) 104 may or may not be actively inserting messages into communications session 114. The one or more automated agents 104 may be implemented by a user communications system 102. User A 110 may be engaged in a communications session 114 with one or more automated agents 104 to obtain assistance in performing various tasks, to obtain assistance in achieving different goals, to reduce their and/or their family's cognitive load, and the like. Environment 100, communications system 102, and communications session 114 may be similar to those described in U.S. Provisional Patent Application No. 63/720,573, filed Nov. 14, 2024, the entire contents of which are incorporated herein by reference for all purposes.

The user communication system 102 may be implemented to reduce the cognitive load of users and their families by identifying different family goals and generating tasks that may be performed by different family members and/or delegated to other entities (e.g., automated agents 104, human representatives associated with the user communication system 102, third-party services, etc.) for performance on behalf of these users and families. Families is used as an example of a social grouping; however, friends or coworkers or other suitable social groupings may be substituted for families when mentioned herein. In an embodiment, when a user A 110 accesses the user communication system 102 for the first time, user A 110 may be prompted to initiate an onboarding process to obtain identifying information associated with the user A 110 and their family that may be used to identify any tasks that may be performed on behalf of the user A 110 and their family to achieve any family goals or otherwise reduce the cognitive load of the user A 110 and of the family. For instance, the user communication system 102 may prompt the user A 110 to provide detailed information with regard to the composition of the user's family (e.g., number of inhabitants in the user's home, the number of children in the user's home, the number and types of pets in the user's home, etc.), the physical location of the user's home, any special needs or requirements of the user A 110 (e.g., physical or emotional disabilities, etc.), and the like. In some instances, the user A 110 may be prompted to provide demographic information (e.g., age, ethnicity, race, languages written/spoken, etc.). The user A 110 may also be prompted to indicate any personal interests or hobbies that may be used to identify possible experiences that may be of interest to the user A 110 and/or other family members associated with the user A 110. In some instances, the user communication system 102 may prompt the user A 110 to specify any tasks that the user A 110 would like assistance with or would otherwise like to delegate to another entity, such as an automated agent 104 and/or third-party.

In an embodiment, the automated agent 104 is an automated process, such as a bot, that may be configured to automatically engage and interact with user A 110 and other users. For instance, the user communication system 102 may utilize the responses provided by user A 110 and/or other users during the onboarding process to generate a user profile and an automated agent 104 that may automatically communicate with user A 110 through an ongoing communications session 114. The automated agent 104 may be configured to autonomously chat with user A 110 and other users to generate tasks and proposals, perform tasks on behalf of the user A 110 and other users in accordance with any approved proposals, and the like as described herein. The automated agent 104 may be configured according to the parameters or characteristics of user A 110 and other users as defined in the user profile. As the automated agent 104 communicates with user A 110 and other users over time, the automated agent 104 may be updated to improve the automated agent's interaction with user A 110 and other users.

In an embodiment, the user communication system 102 provides an application or web service through which users (such as user A 110) may access an interface 112 for initiating and engaging in communications sessions with automated agents 104 to address different user intents. For example, the user communication system 102 may provide, to user A 110, an application that may be installed and executed from the user's computing device to access, through the interface 112, the user communication system 102. Additionally, or alternatively, a user A 110, through a browser application installed and executed from the user's computing device, may access a website associated with the user communication system 102 and through which the user communication system 102 implements a web service that includes the interface 112. In some instances, to access the interface 112 (either through an application executing on a computing device or through a web service), the user A 110 may be required to provide a set of credentials (e.g., username/password, a cryptographic key or token, biometric information, etc.) that may be used to authenticate and identify user A 110. For example, when user A 110 executes the application or accesses the web service to initiate a new communications session 114 through the user communication system 102, the user communication system 102 may prompt user A 110 to provide a set of credentials associated with the user A 110.

The initial communications session 114 between user A 110 and user B and user C may be centered around a particular topic. User A 110 may initially invoke the automated agent 104 to monitor the conversation for tasks to perform. As an example, user A 110 may tag the automated agent 104 with “@umi” in a message. Other codewords or emojis may be used to invoke the automated agent 104. A specific gesture on a touchscreen or dedicated button on a device may also invoke automated agent 104. At the time of invoking the automated agent 104, user A 110 may not have a specific task to be performed. As an example, communications session 114 shows user A 110 sending a first message with an intent to see a movie. User A 110 does not specify what movie to watch, when to watch, or other details needed for automated agent 104 to perform a task. In some embodiments, as described later herein, the content of the communication session 114 may be monitored and the automated agent may be invoked.

User B and user C also send messages in communications session 114 regarding the topic of watching a movie. After some discussion in the communications session 114, user A 110, user B, and user C reach a consensus to watch a specific movie at night. Automated agent 104 sends a message in communications session 114 to indicate performance of a task of buying tickets to a showing of a specific movie. The message is sent proactively without any user in communications session 114 directly instructing automated agent 104 to proceed.

In an embodiment, to facilitate a proactive response, the user communication system 102 implements a state classification module 106 that is configured to dynamically determine the state of automated agent 104 during the communications session 114. State classification module 106 may be a machine learning model. The states of automated agent 104 may include a processing state, a sleep state, and/or a standby state. A processing state indicates that automated agent 104 has a task to perform. The sleep state indicates that the automated agent 104 does not have a task to perform. A change from the sleep state to the processing state may be invoked by a tag, codeword, or other suitable signal or from the context of the conversation. The standby state indicates that the automated agent 104 is designated to perform a task but sufficient details for the task are not yet available. In FIG. 1, the conversation between user A, user B, and user C provides those details while automated agent 104 is in a standby state. After sufficient details are provided, automated agent 104 can re-enter the processing state to perform the task. The states and the classification are discussed in additional detail throughout this disclosure.

The state classification module 106 may be implemented as an application or process executing on a computer system of the user communication system 102. In some instances, the state classification module 106 may be configured with various special-purpose components that can facilitate real-time or near real-time processing of different communications or messages from any number of different users as these different communications or messages are received. In an embodiment, the state classification module 106 monitors ongoing communications sessions, such as communications session 114, to obtain in real-time or near real-time any communications exchanged between different users and automated agents 104. Further, the state classification module 106 may continuously process historical communications previously exchanged between different users and automated agents 104 to dynamically classify states and to determine the context of these state changes. As described in greater detail herein, this may allow the state classification module 106 to better classify the state of automated agents 104.

In an embodiment, the state classification module 106 implements natural language processing (NLP) or any other language parsing algorithm or executable code to automatically parse the communications exchanged between users and/or an automated agent 104. Through NLP or other language parsing algorithm or executable code, the state classification module 106 may dynamically process exchanged communications into an output state (e.g., sleep, processing, standby). In some instances, the state classification module 106 may further process historical communications exchanged between the users and/or the automated agent 104 to obtain additional contextual information that may be used to supplement the newly obtained exchanged communications. For example, if a newly exchanged communication indicates a user's acknowledgment of a state of the automated agent 104, the state classification module 106 may be updated, retrained, or fine-tuned to process future messages in a communications session 114 more accurately and efficiently to dynamically determine the state of the automated agent, thereby resulting in more accurate and efficient proactive responses.

In an embodiment, the state classification module 106 dynamically trains and implements one or more large language models (LLMs) and/or other generative artificial intelligence processes to classify the automated agent 104 during ongoing communications sessions. For instance, the topic identification module 106 may maintain a known list of keywords, messages, or groups of messages that may serve as a knowledge base corresponding to different classified states for automated agents 104 of the user communication system 102.

In an embodiment, the state classification module 106, through this known states datastore or other datastore, maintains different known states that may be associated with different communications. For instance, the state classification module 106 may process received communications exchanged between users and automated agents 104 to dynamically classify states consistent with the known states datastore. As this corpus of communications may be obtained from myriad data sources (e.g., from historical conversations maintained by the user communication system 102, from sample communications provided by third-party entities, from sample communications provided by an administrator of the user communication system 102, etc.), the state classification module 106 may be implemented using thousands, tens of thousands, or more processes that are configured to operate in parallel to process these available communications and generate corresponding states.

The one or more LLMs and/or other generative artificial intelligence processes implemented by the state classification module 106 are, in an embodiment, dynamically trained using a dataset comprising a large corpus of sample communications/messages (e.g., historical communications/messages, hypothetical communications/messages, combinations of historical and hypothetical communications/messages, etc.) and states corresponding to the sample communications/messages. The one or more LLMs and/or other generative artificial intelligence processes may be initialized with a first set of values corresponding to different hyperparameters or other coefficients that, in combination, are used to derive an output given a sample input (e.g., sample communications/messages). Using this initial iteration of the one or more LLMs or other generative artificial intelligence processes, the state classification module 106 may process the dataset of sample communications/messages to generate an output. This output may specify, for each sample communication or message, a topic corresponding to the communication or message. The one or more LLMs or other generative artificial intelligence processes may compare the output (e.g., predicted topics) to the expected topics included in the dataset. Based on this comparison, the one or more LLMs or other generative artificial intelligence processes may dynamically update the values corresponding to the different hyperparameters or other coefficients and again process the dataset to generate new outputs. This process may be repeated numerous times until an iteration of the one or more LLMs or other generative artificial intelligence processes is obtained that satisfies one or more accuracy or predictability thresholds.

In response to a communication or message exchanged by the user A 110 through the ongoing communications session 114, the state classification module 106, through the one or more LLMs or other generative artificial intelligence processes, may dynamically identify a state that is derived from the known states datastore or other datastores maintained by the state classification module 106. In an embodiment, as the state classification module 106 identifies a state associated with the ongoing communications session 114, the state classification module 106 transmits these identified states and the conversation data corresponding to the ongoing communications session 114 (e.g., the exchanged communications and any available historical communications exchanged between the user A 110 and the automated agent 104).

In an embodiment, the state classification module 106 may continuously monitor communications exchanged through the communications sessions to dynamically reclassify the state.

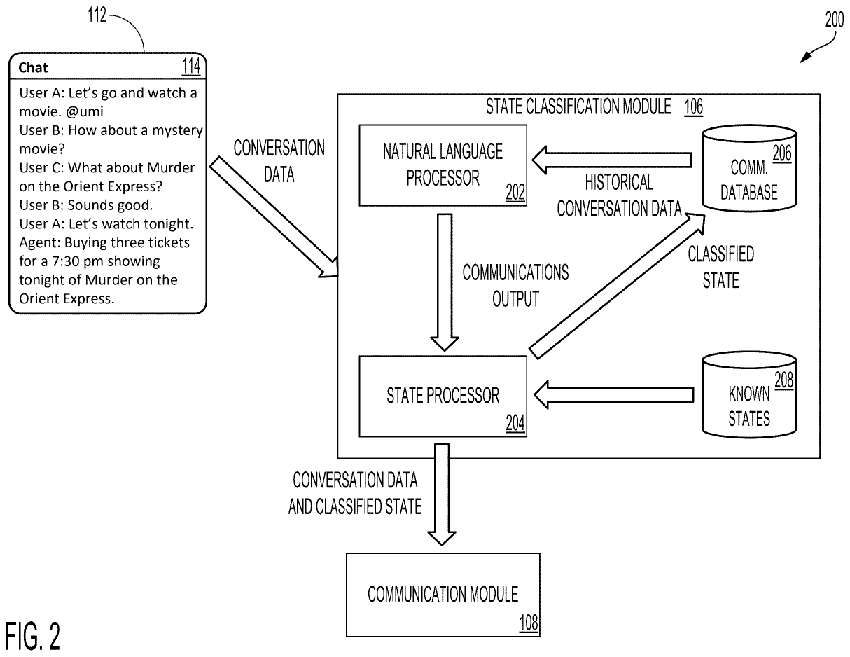

FIG. 2 shows an illustrative example of an environment 200 in which a state classification module 106 dynamically processes conversation data corresponding to an ongoing communications session 114 to classify the state of the automated agent in accordance with at least one embodiment. In the environment 200, the state classification module 106 continuously and in real-time or near real-time obtains conversation data corresponding to different communications exchanged between a user and an automated agent through an ongoing communications session 114. As noted above, this ongoing communications session 114 may be facilitated through an interface 112 provided by the user communication system, such as through an application executing on a user's computing device or through a web service provided by the user communication system.

In an embodiment, the state classification module 106 implements a natural language processor 202 that is configured to perform NLP or any other language parsing on received conversation data to convert the conversation data into a communications output. The communications output may include a distilled version of the conversation or a set of keywords from the conversation data. As illustrated in FIG. 2, the natural language processor 202 may further obtain from a communications database 206, historical conversation data corresponding to the ongoing communications session 114 to obtain any previously exchanged communications and any previously classified states associated with the ongoing communications session 114. The natural language processor 202 may use the historical conversation data corresponding to the ongoing communications session 114 and the previously classified states to determine the context of the newly obtained conversation data and, based on this context, refine the communications output corresponding to the conversation data.

The natural language processor 202, in an embodiment, is a machine learning algorithm or artificial intelligence that is dynamically trained to process conversation data obtained through ongoing communications sessions (such as ongoing communications session 114) to convert the conversation data into a communications output. The natural language processor 202 may be dynamically trained using a dataset of sample communications (e.g., historical communications, hypothetical communications, combinations of historical and hypothetical communications, etc.) and sample outputs corresponding to the sample communications. To dynamically train the natural language processor 202, the state classification module 106 may generate an initial iteration of the natural language processor 202. For instance, the state classification module 106 may initialize a set of coefficients or hyperparameters randomly according to a Gaussian distribution with low variance centered around zero. Using this initial iteration of the natural language processor 202, the state classification module 106 may process the dataset of sample communications and corresponding sample outputs to generate a communications output. This output may include only specific words or phrases from the conversation (e.g., “dinner”, “tonight”), which may be used for classifying a state.

Once the natural language processor 202 is trained to convert conversation data into different communications outputs, the natural language processor 202 may process the received conversation data from the ongoing communications session 114 and the historical conversation data from the communications database 206 into a particular communications output corresponding to the obtained conversation data. The natural language processor 202 may transmit this communications output to a state processor 204 of the state classification module 106 to identify a state associated with the ongoing communications session 114. The state processor 204, in an embodiment, implements a machine learning algorithm or artificial intelligence that is dynamically trained to compare received communications outputs to known states, as described above in connection with FIG. 1. In some embodiments, natural language processor 202 and state processor 204 may be the same. The known states corresponding to communications outputs may be maintained in a known states datastore 208. These known states may be generated by the user communication system or other entity associated with the user communication system based on different available sources. For instance, the user communication system may evaluate historical conversation data corresponding to prior communications sessions between different users and automated agents to identify any states associated with these prior communications sessions. The user communication system may annotate these prior communications sessions and generate states corresponding to the communications. Further, the user communication system may process feedback from different users corresponding to different states discussed during communications sessions with different automated agents. This feedback may include indications of automated agent performance in classifying states during communications sessions and in providing relevant responses to user communications. Thus, the user communications system may further annotate this feedback and corresponding communications to generate states corresponding to these communications. In some embodiments, communications database 206 and known states datastore 208 may be the same database.

Through the machine learning algorithm or artificial intelligence, the state processor 204 may determine the state in real-time or near real-time as the communications outputs are obtained from the natural language processor 202. In an embodiment, as the state embedding processor 204 identifies different states associated with the ongoing communications session 114, the state embedding processor 204 transmits these classified states and the conversation data corresponding to the ongoing communications session 114 (e.g., the exchanged communications and any available historical communications associated with the ongoing communications session 114). The conversation data transmitted may include one or messages an automated agent may include in the communications interface associated with the classified state. Additionally, the state processor 204 may update the communication database 206 to indicate, for the ongoing communications session 114, the one or more classified states. This may allow the natural language processor 202 to determine the context of new conversation data as the new conversation data is received and as described above.

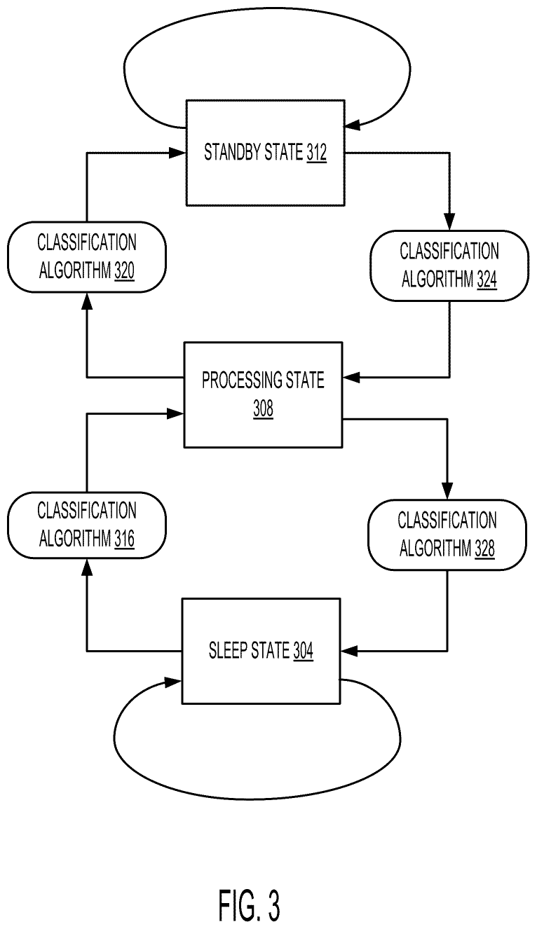

FIG. 3 shows a process of classifying states of an automated agent. The automated agent may be in a sleep state 304. Sleep state 304 may indicate that the automated agent has no task to perform, including any task that may require additional details for performance.

Classification algorithm 316 may process conversation data from an interface to classifying the automated agent in a processing state 308 from sleep state 304. In some embodiments, classification algorithm 316 may detect a keyword, codeword (e.g., “@umi”), instruction, or other suitable device in a message. In some embodiments, classification algorithm 316 may include a state classification module, including state classification module 106. Classification algorithm 316 may include a machine learning model, including a natural language processor, which may include natural language processor 202 or any described herein. Classification algorithm 316 may process a message or a group of messages to determine that a task is to be performed, even if the message or group of messages does not explicitly request for a specific task to be performed.

For example, conversation in a group chat may be about watching movies. The conversation may not invoke a codeword to classify the automated agent into a processing state 308. However, the conversation may progress such that the predicted next message would be to instruct the automated agent to enter the processing state. A transformer in a machine learning model can be trained to predict this next message. Training a transformer to predict the next message in a conversation may involve creating a complex representation of conversational context that captures patterns of human dialogue. The model may include encoding the entire conversation history, converting each message into a numerical representation that captures semantic meaning and contextual relationships. During training, the transformer may use attention mechanisms to analyze how different parts of the conversation interact, learning to weigh the importance of previous messages in predicting the upcoming response. The model may be trained using a large dataset of human conversations, with the objective of maximizing the probability of correctly predicting the next message given the preceding dialogue context. This process may involve multiple training iterations where the model's neural networks may adjust their internal weights, gradually improving its ability to capture the subtle linguistic and contextual cues that determine natural conversational flow. Advanced techniques like context windowing and contextual embedding may help the transformer understand longer-term dependencies and maintain coherence across extended conversational exchanges. If the predicted next message is a command to perform a task, classification algorithm 316 may proactively classify the automated agent in processing state 308 without waiting for a message from a user. Classification algorithm 316 may ask one or more users to confirm the classification to processing state 308.

Processing state 308 is a classification of the automated agent that indicates a task is to be performed. If there is sufficient information to perform the task, then the automated agent may perform the task. Classification algorithm 328 would receive a tag or other indication from the automated agent that the task has been performed. For example, the automated agent may generate a task message indicating that the task has been performed. As another example, the automated agent may set a flag in a database to indicate task completion. With task completion, classification algorithm 328 may classify the automated agent back in sleep state 304. Classification algorithm 328 may ask one or more users to confirm the classification to sleep state 304.

A task may not be performed without additional information. For example, in communications session 114, the first message is “Let's go and watch a movie. @umi”. The task to be performed may be determined to be reserving a movie. However, details, such as the movie title and the time, are missing. Classification algorithm 320 may analyze one or more messages and determine additional information is needed. Classification algorithm 320 may classify the automated agent in a standby state 312. The standby state may indicate that the automated agent requires additional information to perform a task. In embodiments, classification algorithm 320 may include a state classification module, including state classification module 106.

The automated agent in standby state 312 may continue to monitor messages in the communications session 114. Additional messages may be exchanged between users of the set of users. In some embodiments, the automated agent may exchange a message in the communications session 114. These messages may be processed by classification algorithm 324. Classification algorithm 324 may include any classification algorithm described herein. Classification algorithm 324 may include a state classification module, including state classification module 106.

Classification algorithm 324 may process messages to determine when details are provided by the messages. Classification algorithm 324 may include a task detail module that identifies missing details. The task detail module may process messages to determine when the details are provided by messages. In some embodiments, the automated agent may generate a message soliciting details from the set of users or providing information to the set of users to facilitate the set of users to agree on the required details. When the additional details are provided in the communications session, classification algorithm 324 may classify the automated agent into processing state 308. Classification algorithm 324 may ask one or more users to confirm the classification to processing state 308.

With sufficient details for the task, the automated agent may perform the task in processing state 308. The automated agent may send one or more messages describing progress in performing the task. For example, the automated agent may indicate that it is about to perform the task, it is performing the task, and it has performed the task. These additional messages may allow the set of users time to correct or amend the task to be performed or to cancel the performance of the task by the automated agent.

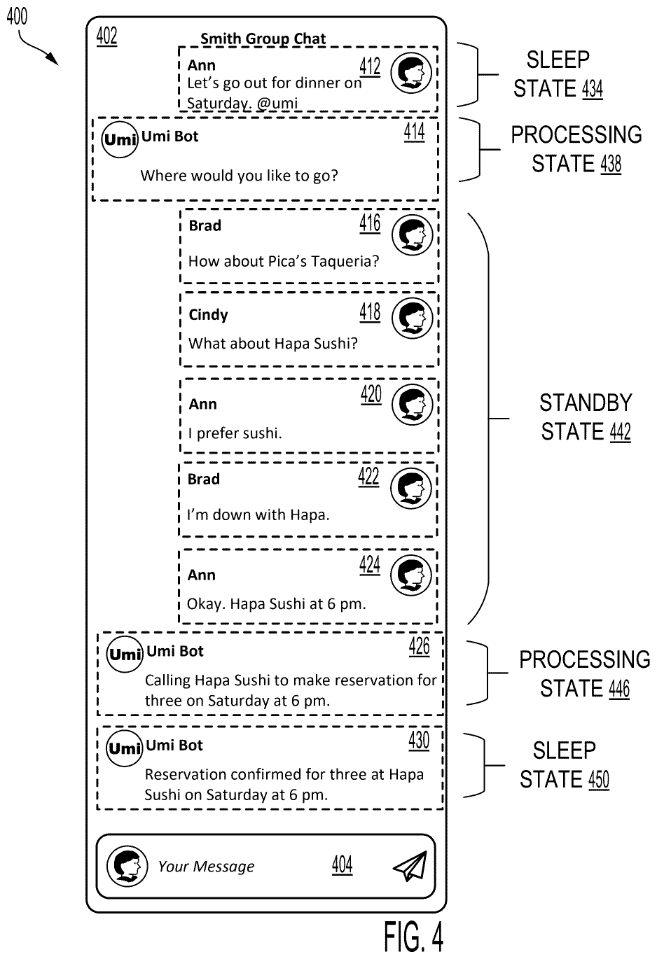

FIG. 4 shows an example of an interface 400 and the different states for the automated agent. Interface 400 displays a communications session 402 between three users and an automated agent. Interface 400 includes input field 404 to enter a message in communications session 402. Communications session 402 may start with the automated agent in sleep state 434. A message 412 from user Ann includes a keyword (“@umi”) that wakes the automated agent from sleep state 434 into processing state 438. The automated agent “Umi Bot” sends a message 414 that indicates it has a task to perform but is waiting for additional information. The automated agent then enters standby state 442 to await further additional information.

Users Ann, Brad, and Cindy discuss different restaurant options in messages 416, 418, 420, and 422. Message 424 summarizes a consensus for the restaurant and chooses a time for dinner. The automated agent processes the messages through a machine learning model and/or a natural language processor. The automated agent determines that sufficient additional information for the task has been provided based on the messages. Messages 416-424 provide a consensus on the restaurant.

While messages 416-424 did not provide a consensus on the time for dinner. The automated bot nevertheless determined that the time was sufficient for performing the task. The determination may be through a machine learning model or algorithm that processes multiple specific types of input data. For example, the inputs may include user calendar data indicating scheduled events and open time slots; user profile data identifying personal preferences such as typical dining hours or frequency of social events; geolocation data showing where users are likely to be at certain times; and/or historical behavioral data capturing prior decisions, such as deference to particular users'choices. By combining these inputs, the model generates a comprehensive evaluation of whether a proposed time is suitable.

The machine learning model may have been trained on a combination of individual user data and broader datasets collected from larger populations. Training could involve supervised learning techniques, where historical examples of successful scheduling outcomes are labeled to teach the model how to recognize desirable conditions. Alternatively, reinforcement learning methods may be applied, where the model improves over time based on feedback loops when consensus is or is not achieved. The training process may also weight certain inputs (such as calendar conflicts) more heavily than others, depending on observed success in past outcomes.

The outputs from the trained model may then be further analyzed and translated into actionable results. For instance, if the output indicates no scheduling conflicts in the calendar data, the automated bot may confirm the proposed time. If the output indicates users'geolocations are within driving range of the restaurant, the system may validate the restaurant as an appropriate venue. If the model predicts, based on historical deference patterns, that Brad and Cindy typically follow Ann's choice, the agent may assign greater weight to Ann's preference in determining consensus. Additionally, when the bot applies a threshold objection period, the model output regarding likely response times is processed to finalize whether consensus has been reached. In this way, the ML/AI outputs are both products of a trained system and instrumental in resolving scheduling decisions.

The automated agent enters a processing state 446 again with all the necessary information to perform a task. The automated agent sends message 426 to indicate that it is about to perform the task. Message 426 may also provide an opportunity for a user to object to the planned task within a threshold amount of time, which may be the same or different as other threshold times.

The automated agent performs the designated task. In some embodiments, the automated agent may enlist assistance of a human agent or another automated or non-automated service to perform the designated task. The automated agent sends message 430 to indicate completion of the task. The automated agent then enters sleep state 450.

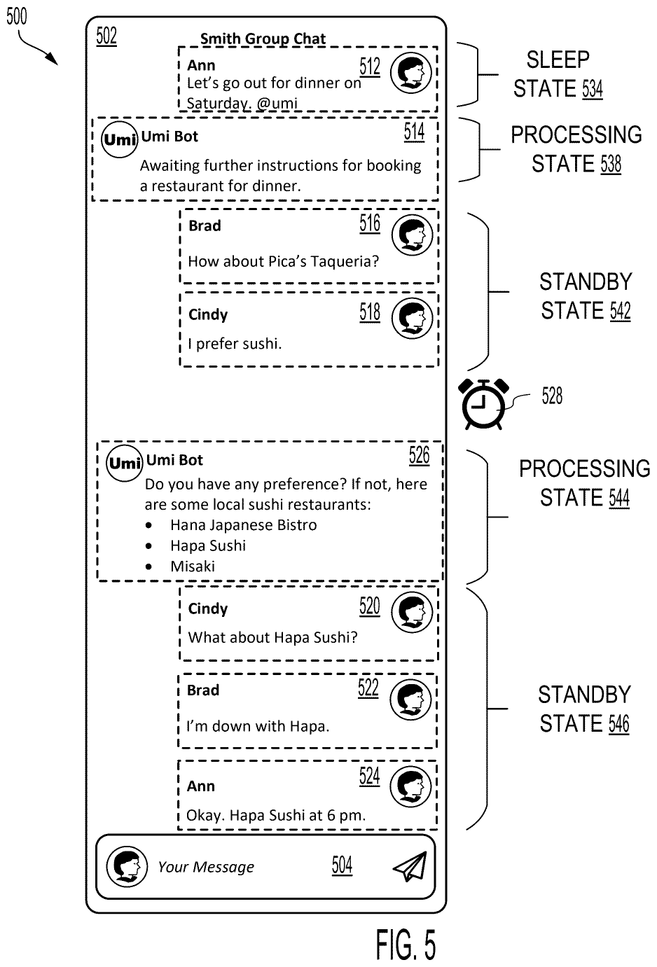

FIG. 5 shows an example of an interface 500 and the different states for the automated agent. Interface 500 displays a communications session 502 between three users and an automated agent. Interface 500 includes input field 504 to enter a message in communications session 502. Communications session 502 is similar to communications session 402 but demonstrates a conversation where the automated bot assists in the production of the additional information from the users.

Communications session 502 may start with the automated agent in sleep state 534. A message 512 from user Ann includes a keyword (“@umi”) that wakes the automated agent from sleep state 534 into processing state 538. The automated agent “Umi Bot” sends a message 514 that it has a task to perform but is waiting for additional information. The automated agent then enters standby state 542 to await further additional information.

Messages 516 and 518 discuss possible restaurant options. No agreement is reached through the two messages. Indeed, message 518 indicates a rejection of the suggested restaurant in message 516.

Some amount of time 528 passes without another message on the restaurant topic. The amount of time 528 may be greater than a threshold time expected for conversations. The threshold time may be determined through statistical methods of past conversations between the given users or a larger set of users. The threshold time may be a time selected by a user (e.g., user Ann) for the automated bot to wait before continuing. The threshold time may be a time determined by a machine learning model or algorithm that optimizes time to start performing a task and/or reduces the likelihood of an objection or negative feedback from a user to intervention by the automated bot.

The machine learning model may process multiple types of input data to determine such a threshold. For example, the inputs may include historical conversation data reflecting average and maximum response times of particular users, contextual data such as day of the week or time of day when responses are more or less frequent, user profile preferences regarding how quickly decisions should be made, and/or behavioral data capturing how often delays result in objections or dissatisfaction. By considering these diverse inputs, the model can generate a dynamic and context-aware threshold time.

The model may have been trained using historical datasets of conversations, labeled with outcomes indicating whether interventions occurred at appropriate times or whether objections were raised. Supervised learning techniques may be used to train the model to recognize patterns in response timing that lead to successful task initiation. Additionally, reinforcement learning techniques may be applied, where the model receives positive or negative feedback based on whether its predicted threshold times minimized objections while maintaining efficiency. Over time, the model may adjust weighting of different inputs (e.g., prioritizing user-specific response patterns over general averages) to improve accuracy in predicting optimal threshold times.

The automated bot enters processing state 544. The task the automated bot has to perform may be a subtask of the task indicated in message 514. For example, the task in message 514 is to book a restaurant for dinner. The task for processing state 544 is to solicit additional information from users on the restaurant to perform the task of booking a restaurant for dinner.

The automated bot may process one or more previous messages through a machine learning algorithm and/or a natural language processor to determine that a list of sushi restaurants would help the users reach a decision.

The inputs to the machine learning model for such a determination may include elapsed time since the last user contribution in the conversation; overall time that the topic (e.g., restaurant selection) has remained unresolved without consensus; the proximity of the current time to the scheduled event (e.g., a dinner planned for that evening); and/or (iv) contextual cues such as repeated mentions of a cuisine type or user preferences from prior conversations. These inputs allow the model to recognize when intervention with supplementary information is likely to help advance the conversation toward resolution.

The model may be trained using historical conversation datasets annotated with outcomes reflecting whether provision of additional information led to successful consensus or whether conversations continued without intervention. Supervised learning methods may teach the model to identify features that predict successful outcomes when the bot contributes extra content. Reinforcement learning techniques may further refine the model by rewarding it when suggested interventions (such as listing restaurants) accelerate consensus or improve user satisfaction, while penalizing it when unnecessary interventions disrupt the natural flow of conversation. Over time, the model may learn to weigh factors such as elapsed silence, approaching deadlines, and unresolved discussion length to optimize when and how the bot should contribute supplemental information.

The automated bot may send an automated or non-automated agent to conduct a search of sushi restaurants near the users. The automated bot and/or agents may process user preferences in user profiles to boost or eliminate sushi restaurants for consideration. For example, a user profile may indicate repeated visits to a certain sushi restaurant, and that restaurant may be included in a recommendation. As another example, a user profile may indicate a recent visit to a sushi restaurant, and because of the recency, the sushi restaurant may be eliminated from a recommendation or de-emphasized in a recommendation (e.g., through lower placement in a list).

The automated bot sends a message 526 listing possible sushi restaurants. The automated bot goes back to standby state 546 to wait for the additional information needed for both the subtask and main task. Message 526 catalyzes further conversation from the users, which may not have occurred but for the intervention from automated bot. Messages 520, 522, and 524 are spurred by message 526. The users decide on a sushi restaurant. User Ann sends a message 524 detailing the choice of restaurant and a time for dinner. This message is identical to message 424. Automated bot may proceed in the same or similar manner as shown in FIG. 4 following message 424.

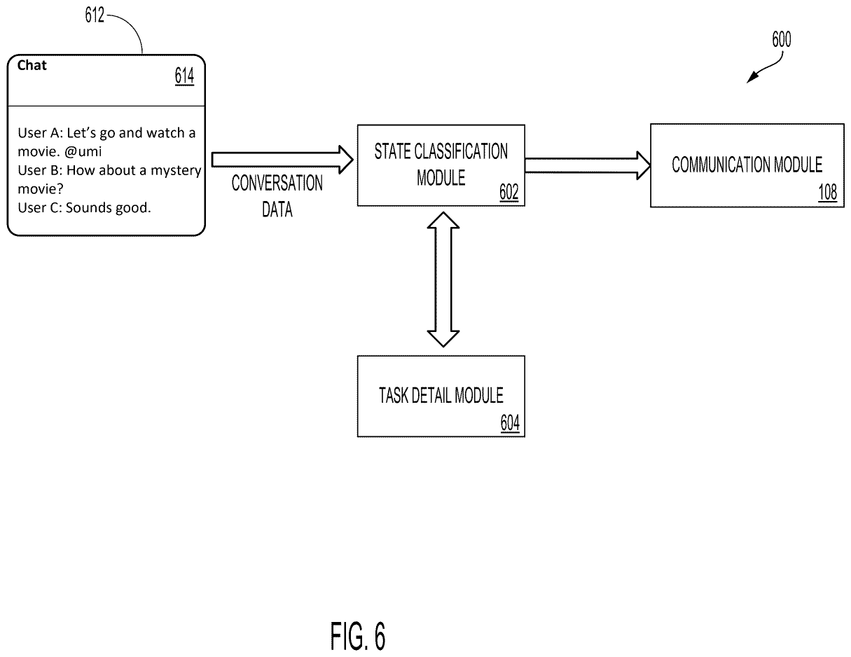

FIG. 6 shows a process flow 600 for processing conversation data for the goal of performing tasks. FIG. 6 shows a chat interface 612 with a communications session 614. Communications session 614 may include messages from a set of users. Conversation data from communications session 614 may be sent to and processed by state classification module 602. State classification module 602 may be state classification module 106 or any state classification module described herein.

Conversation data may be sent from state classification module 602 to task detail module 604. In some embodiments, conversation data may be sent directly from communications session 614 to task detail module 604 instead of through state classification module 602. Task detail module 604 may process conversation data to determine if additional details are needed to perform a task. Task detail module 604 may output a determination of whether additional details are needed to state classification module 602. Multiple task detail modules may be present. State classification module 602 may send the classified state and the task detail information to communication module 108. Communication module 108 may generate a message for inclusion in communications session 614.

As an example, conversation data may be received by state classification module 602. State classification module 602 may classify the state of the automated agent as a processing state from a sleep state. The same conversation data may then be passed to task detail module 604. Task detail module 604 may process the conversation data and determine that additional information is needed to perform the task. Task detail module 604 may send the determination to state classification module 602. The determination may include a category (e.g., time, location, guests, deadline) of the missing information. State classification module 602 may receive the determination. State classification module 602 may then classify the state of the automated agent into a standby state from the processing state. State classification module 602 may send the state and the additional information determination to communication module 108. Communication module 108 may then generate a message based on the state and the additional information. For example, the message may include message 414 or message 514.

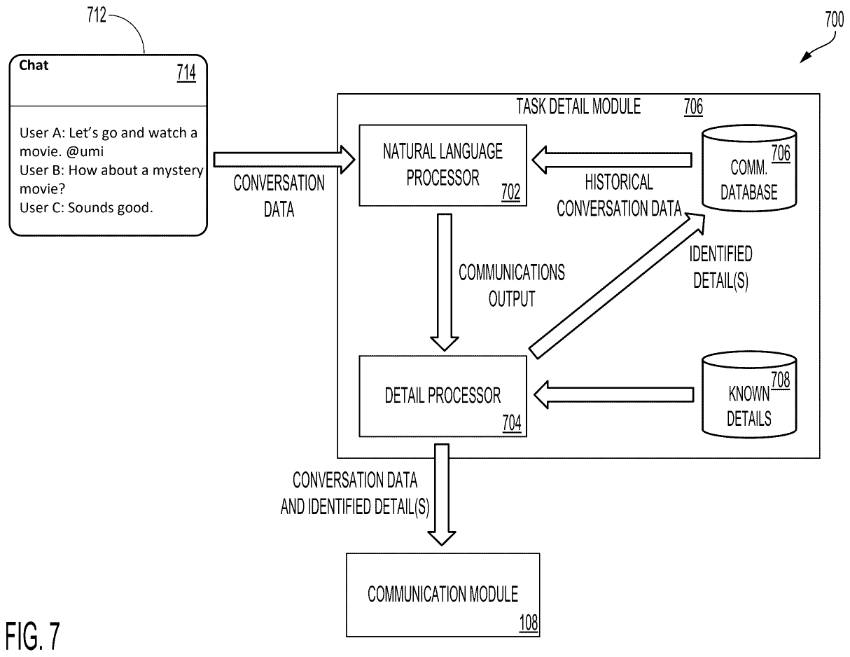

FIG. 7 shows an example of an environment 700 in which a task detail module 706 dynamically processes conversation data corresponding to an ongoing communications session 714 to identify details for the performance of a task by an automated agent in accordance with at least one embodiment. In environment 700, task detail module 706 continuously and in real-time or near real-time obtains conversation data corresponding to different communications exchanged between a user and an automated agent through an ongoing communications session 714. This ongoing communications session 714 may be facilitated through an interface 712 provided by the user communication system, such as through an application executing on a user's computing device or through a web service provided by the user communication system.

In an embodiment, conversation data associated with the ongoing communications session may be received by a natural language processor 702. The natural language processor 702 may be implemented using a computer system or as an application or other executable code implemented on a computer system. The natural language processor 702, in an embodiment, is a machine learning algorithm or artificial intelligence that is dynamically trained to process conversation data obtained through ongoing communications sessions (such as ongoing communications session 714) to convert the conversation data into communications outputs. The natural language processor 702 may be dynamically trained using a dataset of sample communications (e.g., historical communications, hypothetical communications, combinations of historical and hypothetical communications, etc.) and corresponding sample communications outputs. To dynamically train the natural language processor 702, the task detail module 706 may generate an initial iteration of the natural language processor 702. Using this initial iteration of the natural language processor 702, the task detail module 706 may process the dataset of sample communications to generate an output. This output may specify keywords or topics of the conversation data.

Once the natural language processor 702 is trained to convert conversation data into communications outputs, the natural language processor 702 may process the received conversation data from the ongoing communications session 714 and the historical conversation data from the communications database 706 into a communications output corresponding to the obtained conversation data. The natural language processor 702 may transmit this communications output to a detail processor 704 of the task detail module 706 to identify a set of details associated with the ongoing communications session 714. In some embodiments, natural language processor 702 and detail processor 704 may be the same processor.

The detail processor 704, in an embodiment, implements a machine learning algorithm or artificial intelligence that is dynamically trained to compare received communications outputs to known details, as described above in connection with FIG. 6. The known details (e.g., missing information or needed information for a task) may be maintained in a known details datastore 708. These known details may be generated by the user communication system or other entity associated with the user communication system based on different available sources. For instance, the user communication system may evaluate historical conversation data corresponding to prior communications sessions between different users and automated agents to identify any missing or necessary details associated with these prior communications sessions. Further, the user communication system may process feedback from different users corresponding to different details discussed during communications sessions with different automated agents. This feedback may include indications of automated agent performance in identifying details during communications sessions and in providing relevant responses to user communications. Thus, the user communications system may further annotate this feedback and corresponding communications to generate details corresponding to these communications. In some embodiments communication database 706 and known details datastore 708 may be the same database.

Through the machine learning algorithm or artificial intelligence, the detail processor 704 may identify details in real-time or near real-time as communications outputs are obtained from the natural language processor 702. In some embodiments, known states datastore 708 may be supplemented with information from other systems, e.g., through using APIs (application programming interfaces) to interact with other systems. In an embodiment, as the detail processor 704 identifies different details associated with the ongoing communications session 714, the detail processor 704 transmits these identified details and the conversation data corresponding to the ongoing communications session 714 (e.g., the exchanged communications and any available historical communications associated with the ongoing communications session 714). In embodiments, the detail processor 704 may update the communication database 706 to indicate, for the ongoing communications session 714, the one or more identified details. This may allow the natural language processor 702 to determine the context of new conversation data as the new conversation data is received and as described above.

One or more LLMs or other generative artificial intelligence processes may be further trained in conjunction with retrieval-augmented generation (RAG) to improve the predictability of the one or more LLMs or other generative artificial intelligence processes in identifying details in communications exchanged between users and automated agents during ongoing communications sessions. For instance, in addition to evaluating the one or more LLMs or other generative artificial intelligence processes according to linguistic metrics (e.g., Bilingual Evaluation Understudy (BLEU) scores, language fluency metrics, semantic consistency metrics, etc.), the task detail module 706 may determine whether the one or more LLMs or other generative artificial intelligence processes are accurately leveraging the available known details datastore or other datastores to generate outputs (e.g., topics) that are expressed in the sample communications/messages. For instance, the task detail module 706 may evaluate the output generated by the one or more LLMs or other generative artificial intelligence processes to determine whether the one or more LLMs or other generative artificial intelligence processes are correctly converting the sample communications/messages into an output and identifying appropriate task details. Based on this evaluation, the task detail module 706 may dynamically update the one or more LLMs or other generative artificial intelligence processes as described above to improve the accuracy of these one or more LLMs or other generative artificial intelligence processes in identifying the relevant details for tasks during ongoing communications sessions.

As additional conversation data is generated, task detail module 706 may also determine that details, previously determined to be missing or necessary, have been supplied through the messages of the communications session. The identification of these missing details may be performed by the natural language processor 702 and detail processor 704 in a similar fashion as for identifying missing details.

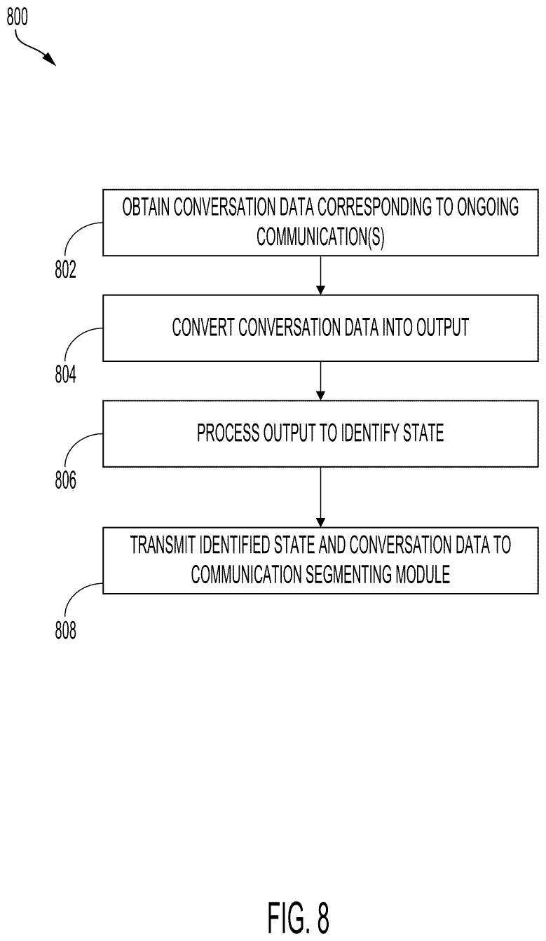

FIG. 8 shows an illustrative example of a process 800 for classifying states of an automated agent during an ongoing communications session. The process 800 may be performed by the state classification module described above in connection with FIGS. 1, 2, and 3. At step 802, the state classification module may obtain conversation data corresponding to ongoing communications being exchanged between one or more users and an automated agent. For instance, the state classification module may continuously, and in real-time or near real-time, monitor an ongoing communications session to dynamically detect any communications being exchanged over the ongoing communications session. In some embodiments, the state classification module may run on a periodic schedule. For example, the state classification module may repeatedly run after a set interval of time (e.g., 5 minutes, 10 minutes, 30 minutes, 60 minutes).

At step 804, the state classification module may convert the obtained conversation data into a communications output. As noted above, the state classification module may implement a natural language processor that is configured to perform NLP or other language parsing on the obtained conversation data to convert the conversation data into a communications output. This natural language processor may further obtain historical conversation data corresponding to the ongoing communications session to obtain any previously exchanged communications and any previously classified states associated with the ongoing communications session. The natural language processor may use the historical conversation data corresponding to the ongoing communications session and the previously classified states to determine the context of the newly obtained conversation data and based on this context, refine the communications output corresponding to the conversation data.

At step 806, the state classification module may process the output to identify a state. The state classification module, in an embodiment, implements a machine learning algorithm or artificial intelligence that is trained to compare communications outputs to known states. The known states may be maintained by the user communication system in a known states datastore or other knowledge base. These known states may be generated by the user communication system or other entity associated with the user communication system based on different available sources. For instance, the user communication system may evaluate historical conversation data corresponding to prior communications sessions between different users and automated agents to identify any states associated with these prior communications sessions. The user communication system may annotate these prior communications sessions and generate states corresponding to the communications. Further, the user communication system may process feedback from different users corresponding to different states discussed during communications sessions with different automated agents. This feedback may include indications of automated agent performance in identifying ongoing states during communications sessions and in providing relevant responses to user communications. Thus, the user communications system may further annotate this feedback and corresponding communications to generate states corresponding to these communications outputs.

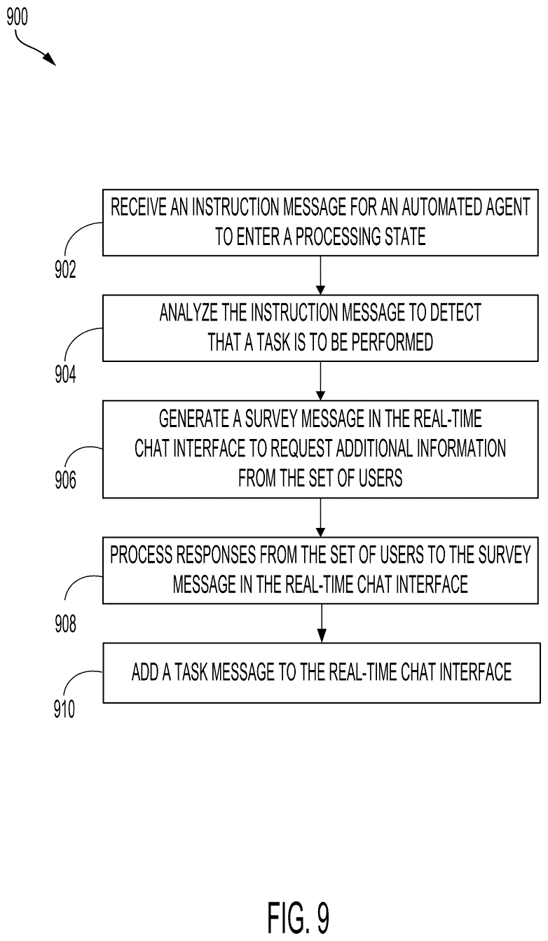

FIG. 9 shows an example method 900 for improving real-time chat interface efficiency. Method 900 may be implemented on a computer.

At block 902, method 900 includes receiving an instruction message for an automated agent to enter a processing state. The instruction message may be transmitted through a real-time chat interface by a user of a set of users. The instruction message may include a keyword, which triggers the automated agent to enter the processing state. In some embodiments, the instruction message may not be a direct instruction or have a direct keyword. Instead, method 900 may process the conversation data through a machine learning model to determine that the automated agent should be in a processing state, even if no explicit instruction to enter the processing state is received. For example, a natural language processor may process the conversation data to determine a task to be performed, and the automated agent may then enter the processing state. Method 900 may include receiving one or more instruction messages. The automated agent may have previously been in a sleep state before the processing state, and such a state classification change may be as described in FIGS. 3, 4, 5, or 8. The instruction may be similar to message 412, message 512, or related examples.

At block 904, method 900 includes analyzing the instruction to detect that a task is to be performed. Analyzing the instruction includes determining that performing the task requires additional information. Determining includes classifying the automated agent in a standby state. Analyzing the instruction may include processing the instruction through a natural language processor to determine the task. Analyzing the instruction may include processing the instruction through the real-time chat interface through a natural language processor to determine that additional information is required. The processing of the instruction for the determination that additional information is required may be performed by task detail module 604 or task detail module 706.

Classifying the automated agent in a standby state may include processing conversation data into a machine learning model to determine a communications output, which may be a more concise version of the conversation data (e.g., a summary or keywords). Classifying the automated agent in the standby state may include processing conversation data in a machine learning model. The classification may be as described in FIGS. 3, 4, 5, or 8.

At block 906, method 900 includes generating a survey message in the real-time chat interface to request additional information from the set of users. Generating the survey message may include comparing a period of time elapsed from a message to a threshold time. The message may be the most recent message in the real-time chat interface. In some embodiments, the message may be the most recent message related to the current topic, as determined by a natural language processor or machine learning algorithm. The threshold time may be a user-selectable time. In some embodiments, the threshold time may be determined by an algorithm or machine learning model. The algorithm or machine learning model may process previous conversations, including conversations between one or more of the set of users, to determine the threshold time. The threshold time may be determined based on an average (e.g., mean, median, mode) before a user asks the automated bot to intervene. In some embodiments, the threshold time may be selected based on reducing the time or number of messages needed to perform the task.

In some embodiments, generating the survey message may include processing messages from the set of users into a natural language processor to determine that the additional information has not been provided. Processing the messages may be as described with FIG. 7. The set of users may exchange messages without arriving at a consensus as to the additional information.

The survey message may include a question to the set of users. For example, the question may directly ask users to supply the additional information (e.g., location, event, date, time, etc.). As another example, the question may ask users if they wish the automated bot to provide suggestions, recommendations, or clarifications on the additional information. In some embodiments, the survey message may involve processing user profiles, including user history, messages, and preferences, as described in FIG. 5. The survey message may involve processing the user profile or aspects of the user profile into a machine learning model to determine suggestions. The survey message may involve processing previous conversations between users of the set of users into a machine learning model to determine tendencies with the users (e.g., deference to a particular user's suggestion, preferred locations, preferred activities, preferred times) Such processing of the user profile may eliminate, add, emphasize, or de-emphasize possible recommendations in a survey message.

At block 908, method 900 includes processing responses from the set of users to the survey message in the real-time chat interface. Processing includes inputting the responses into a natural language processor to determine the additional information. Processing response may involve task detail module 604 or task detail module 706. Messages may be similar to messages 520-524. In some embodiments, processing responses may determine that the additional information has not been provide, which may result in the generation of another survey message.

At block 910, method 900 includes adding a task message to the real-time chat interface. Adding the task message includes classifying the automated agent in the processing state. The classification may be as described in FIGS. 3, 4, 5, or 8. The task message may indicate that the task is to be performed, is being performed, or has been performed. The task message may include the additional information. As examples, the task message may be message 426 or message 430.

Method 900 does not include a request from the set of users to perform the task using the additional information, thereby improving the efficiency of the real-time chat interface. The set of users may never send a request to the automated bot to perform a task. As examples, messages 412 and 416-424 and messages 512, 516, 518, and 520-524 do not request the automated bot perform a task. In some embodiments, the details of the task to be performed may be divided among 2, 3, 4, or more messages and/or users.

Method 900 may include receiving feedback from the set of users on the task message. The feedback may include a message in the chat interface indicating that the task should not be performed, that the additional information is incorrect, or that the users have not reached a consensus. Method 900 may include updating a machine learning model or a natural language processor using the feedback. Updating may include correcting the model or processor so that the future responses are not processed to determine that the additional information has been provided.

Method 900 may include adding a status message to the real-time chat interface. The status message may indicate the task to be performed. The status message may indicate additional information is required or may indicate the additional information. The status message may be added before or after any one of blocks 902, 904, 906, 908, and 910.

Method 900 may include performing the task or aspects of the task. Performing the task may include performing computer-implemented operations associated with the task. For example, the task may include making reservations, booking tickets, or scheduling appointments. In some embodiments, performing the task may include sending a communication to a non-automated agent to perform operations. While users may wish for a physical service to be performed (e.g., house cleaning, yard work), the task for the automated agent may be limited to coordinating or scheduling the service.

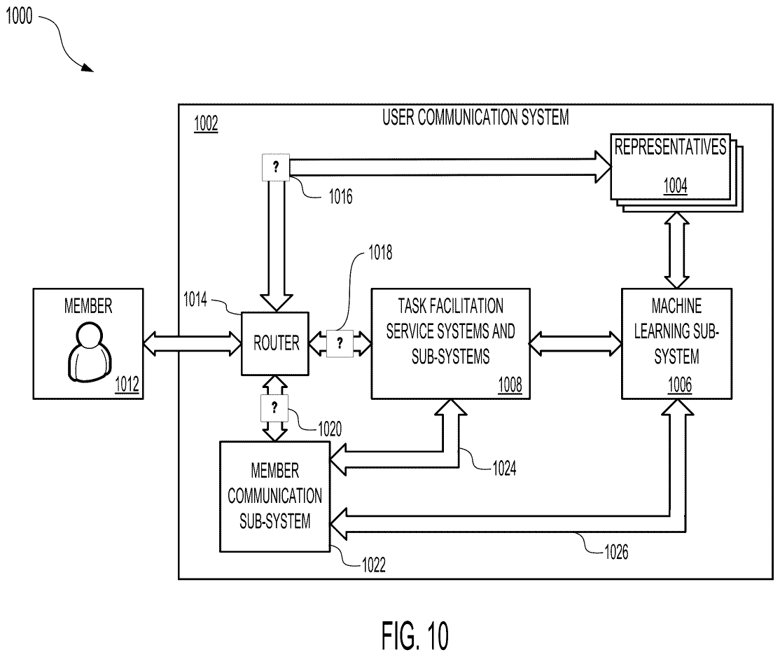

FIG. 10 shows an illustrative example of an environment 1000 in which communications with members are processed in accordance with at least one embodiment. In an embodiment, operations performed by representatives 1004 are partially and/or fully performed using one or more machine learning algorithms, artificial intelligence systems and/or computational models. For example, as the representatives 1004 perform or otherwise coordinate performance of tasks on behalf of a member 1012, the task facilitation service 1002 may update a profile of the member 1012 and/or a computational model of the profile of the member 1012.

In an embodiment, as the representatives 1004 perform or otherwise coordinate performance of tasks on behalf of a member 1012, the task facilitation service 1002 updates a profile of the member 1012 and/or a computational model of the profile of the member 1012 continuously. For example, as a member 1012 communicates with a system of the task facilitation service 1002, the task facilitation service 1002 may update the profile of the member 1012 and/or a computational model of the profile of the member 1012 continuously during the course of the interaction.

In an embodiment, as the representatives 1004 perform or otherwise coordinate performance of tasks on behalf of a member 1012, the task facilitation service 1002 updates a profile of the member 1012 and/or a computational model of the profile of the member 1012 dynamically. For example, as a task is performed on behalf of a member 1012, a vendor performing the task may provide regular updates to the task facilitation service 1002 and the task facilitation service 1002 may update the profile of the member 1012 and/or a computational model of the profile of the member 1012 dynamically at each update from the vendor.

In an embodiment, as the representatives 1004 perform or otherwise coordinate performance of tasks on behalf of a member 1012, the task facilitation service 1002 updates a profile of the member 1012 and/or a computational model of the profile of the member 1012 automatically. For example, when a proposal is generated for the member, the task facilitation service 1002 may update the profile of the member 1012 and/or a computational model of the profile of the member 1012 automatically as part of the proposal generation process.

In an embodiment, as the representatives 1004 perform or otherwise coordinate performance of tasks on behalf of a member 1012, the task facilitation service 1002 updates a profile of the member 1012 and/or a computational model of the profile of the member 1012 in real-time. For example, when a member 1012 accepts a proposal, the task facilitation service 1002 may update the profile of the member 1012 and/or a computational model of the profile of the member 1012 at the time that the proposal acceptance is provided, rather than delaying the update.

In an embodiment, the task facilitation service 1002 updates a profile of the member 1012 and/or a computational model of the profile of the member 1012 using a machine learning sub-system 1006 of the task facilitation service 1002. In an embodiment, a machine learning sub-system 1006 is a component of the task facilitation service 1002 that is configured to implement machine learning algorithms, artificial intelligence systems, and/or computation models. In an example, a machine learning sub-system 1006 may use various algorithms to train a machine learning model using sample and/or live data. Additionally, a machine learning sub-system 1006 may update the machine learning model as new data is received. In another example, the machine learning sub-system 1006 may train and/or update various artificial intelligence systems or generate, train and/or update various computational models. For example, a computational model of the profile of the member 1012 may be generated, trained and/or updated by the machine learning sub-system 1006 as new information is received about the member 1012.

In an embodiment, after the profile of the member 1012 and/or a computational model of the profile of the member 1012 has been updated over a period of time (e.g., six months, a year, etc.) and/or over a set of tasks (e.g., twenty tasks, thirty tasks, etc.), systems of the task facilitation service 1002 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 1002 (e.g., a task recommendation system) can automatically communicate with the member 1012 to obtain any additional information needed and can also generate proposals that may be presented to the member 1012 for performance of these tasks.

In the example illustrated in FIG. 10, communications between the member 1012 and the task facilitation service 1002 may be routed to one or more entities within the task facilitation service 1002. The example illustrated in FIG. 10 shows a communication router 1014 (referred to in the illustration as a “router”) however, as may be contemplated and as illustrated in FIG. 10, the router 1014 is an abstract representation of one or more techniques for routing communications between entities. Accordingly, communications from the member 1012 to the task facilitation service 1002 may be routed to one or more entities of the task facilitation service and communications from the one or more entities of the task facilitation service 1002 may be routed back to the member 1012.

In the example illustrated in FIG. 10, the representatives 1004 can monitor communications between task facilitation service systems and/or sub-systems 1008 and the member 1012 to ensure that the interaction maintains a positive polarity as described herein because the communications can be routed 1016 to the representatives 1004 and also routed 1018 to task facilitation service systems and/or sub-systems 1008. For example, if a member 1012 is interacting with the task recommendation system, the representatives 1004 can determine whether the member 1012 is satisfied with the interaction. If the representatives 1004 determine that the conversation has a negative polarity (e.g., that the member 1012 is not satisfied with the interaction), the representatives 1004 may intervene to improve the interaction.

Similarly, other interactions between task facilitation service systems and/or sub-systems 1008 and the member 1012 may be routed 1020 to a member communication sub-system 1022 which may be configured to monitor the interactions between task facilitation service systems and/or sub-systems 1008 and the member 1012. In an embodiment, the member communication sub-system 1022 can be configured to intercept the interactions between task facilitation service systems and/or sub-systems 1008 and the member 1012 (using, for example, the router 1014). In such an embodiment, all such interactions can be routed 1020 between the member 1012 and the member communication sub-system 1022 and can be routed 1024 between the member communication sub-system 1022 and the task facilitation service systems and/or sub-systems 1008. In such an embodiment, interactions between the task facilitation service systems and/or sub-systems 1008 and the member 1012 may not be routed 1018 directly. In such an embodiment, the representatives 1004 may still monitor interactions between task facilitation service systems and/or sub-systems 1008 and the member 1012 to ensure that the interaction maintains a positive polarity as described above (e.g., by routing 1016 the interactions to the representatives 1004).

In an embodiment, the representatives 1004 can interact with the machine learning sub-system 1006 to update the profile of the member indicating changing member preferences based on an interaction between the representatives 1004 the member 1012. In an embodiment, the task facilitation service systems and/or sub-systems 1008 can interact with the machine learning sub-system 1006 to update the profile of the member when, for example, a proposal is accepted or rejected. Additionally, as illustrated in FIG. 10, the interactions between the task facilitation service 1002 and the member 1012 can be additionally routed 1026 between the member communication sub-system 1022 and the machine learning sub-system 1006. Accordingly, interactions between the member 1012 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 1008 can update the profile of the member 1012 and/or a computational model of the profile of the member 1012 continuously, dynamically, automatically, and/or in real-time. For example, task facilitation service systems and/or sub-systems 1008 can update the profile of the member 1012 and/or a computational model of the profile of the member 1012 using the machine learning sub-system 1006 as described herein. Accordingly, task facilitation service systems and/or sub-systems 1008 can update the profile of the member 1012 and/or a computational model of the profile of the member 1012 to provide up-to-date information about the member based on the member's automatic interaction with the task facilitation service 1002, based on the member's interaction with the representative 1004, and/or based on tasks performed on behalf of the member 1012 over time. This information may also be updated continuously, automatically, dynamically, and/or in real-time as tasks and/or proposals are created, proposed, and performed for the member 1012. This information may also be used by the task facilitation service 1002 to anticipate, identify, and present appropriate or intelligent interactions with the member 1012 (e.g., in response to member 1012 queries, needs, and/or goals).

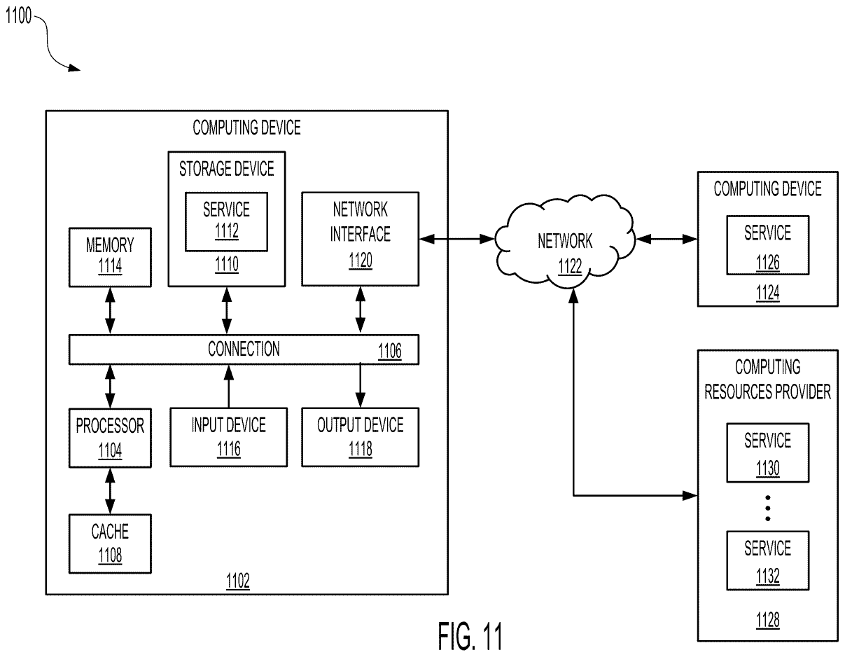

FIG. 11 illustrates a computing system architecture 1100, including various components in electrical communication with each other, in accordance with some embodiments. The example computing system architecture 1100 illustrated in FIG. 11 includes a computing device 1102, which has various components in electrical communication with each other using a connection 1106, such as a bus, in accordance with some implementations. The example computing system architecture 1100 includes a processing unit 1104 that is in electrical communication with various system components, using the connection 1106, and including the system memory 1114. In some embodiments, the system memory 1114 includes read-only memory (ROM), random-access memory (RAM), and other such memory technologies including, but not limited to, those described herein. In some embodiments, the example computing system architecture 1100 includes a cache 1108 of high-speed memory connected directly with, in close proximity to, or integrated as part of the processor 1104. The system architecture 1100 can copy data from the memory 1114 and/or the storage device 1110 to the cache 1108 for quick access by the processor 1104. In this way, the cache 1108 can provide a performance boost that decreases or eliminates processor delays in the processor 1104 due to waiting for data. Using modules, methods and services such as those described herein, the processor 1104 can be configured to perform various actions. In some embodiments, the cache 1108 may include multiple types of cache including, for example, level one (L1) and level two (L2) cache. The memory 1114 may be referred to herein as system memory or computer system memory. The memory 1114 may include, at various times, elements of an operating system, one or more applications, data associated with the operating system or the one or more applications, or other such data associated with the computing device 1102.

Other system memory 1114 can be available for use as well. The memory 1114 can include multiple different types of memory with different performance characteristics. The processor 1104 can include any general purpose processor and one or more hardware or software services, such as service 1112 stored in storage device 1110, configured to control the processor 1104 as well as a special-purpose processor where software instructions are incorporated into the actual processor design. The processor 1104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1104 can be a microprocessor, a microcontroller, a digital signal processor (“DSP”), or a combination of these and/or other types of processors. In some embodiments, the processor 1104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1100, an input device 1116 can represent any number of input mechanisms, such as a microphone for speech, a touch-sensitive screen for gesture or graphical input, keyboard, mouse, motion input, pen, and other such input devices. An output device 1118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1100. In some embodiments, the input device 1116 and/or the output device 1118 can be coupled to the computing device 1102 using a remote connection device such as, for example, a communication interface such as the network interface 1120 described herein. In such embodiments, the communication interface can govern and manage the input and output received from the attached input device 1116 and/or output device 1118. As may be contemplated, there is no restriction on operating on any particular hardware arrangement and accordingly the basic features here may easily be substituted for other hardware, software, or firmware arrangements as they are developed.

In some embodiments, the storage device 1110 can be described as non-volatile storage or non-volatile memory. Such non-volatile memory or non-volatile storage can be a hard disk or other types of computer readable media which can store data that are accessible by a computer, such as flash memory cards, solid state memory devices, digital versatile disks, RAM, ROM, and hybrids thereof.

As described above, the storage device 1110 can include hardware and/or software services such as service 1112 that can control or configure the processor 1104 to perform one or more functions including, but not limited to, the methods, processes, functions, systems, and services described herein in various embodiments. In some embodiments, the hardware or software services can be implemented as modules. As illustrated in example computing system architecture 1100, the storage device 1110 can be connected to other parts of the computing device 1102 using the system connection 1106. In an embodiment, a hardware service or hardware module such as service 1112, that performs a function can include a software component stored in a non-transitory computer-readable medium that, in connection with the necessary hardware components, such as the processor 1104, connection 1106, cache 1108, storage device 1110, memory 1114, input device 1116, output device 1118, and so forth, can carry out the functions such as those described herein.

The disclosed processed for generating and executing experience recommendations can be performed using a computing system such as the example computing system illustrated in FIG. 11, using one or more components of the example computing system architecture 1100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 1104 wherein the code is stored in memory such as memory 1114 as described herein. One or more of a user device, a provider server or system, a database system, or other such devices, services, or systems may include some or all of the components of the computing system such as the example computing system illustrated in FIG. 11, using one or more components of the example computing system architecture 1100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, a mesh of computer systems, a mobile telephone, a server, or a combination of two or more of these.

The memory 1114 can be coupled to the processor 1104 by, for example, a connector such as connector 1106, or a bus. As used herein, a connector or bus such as connector 1106 is a communications system that transfers data between components within the computing device 1102 and may, in some embodiments, be used to transfer data between computing devices. The connector 1106 can be a data bus, a memory bus, a system bus, or other such data transfer mechanism.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1106 can also couple the processor 1104 to a network interface device such as the network interface 1120. It will be appreciated that the network interface 1120 may be considered to be part of the computing device 1102 or may be separate from the computing device 1102. The network interface 1120 can include one or more of a modem, token ring interface, satellite transmission interface, or other interfaces for coupling a computer system to other computer systems. In some embodiments, the network interface 1120 can include one or more input and/or output (I/O) devices. The I/O devices can include, by way of example but not limitation, input devices such as input device 1116 and/or output devices such as output device 1118. For example, the network interface 1120 may include a keyboard, a mouse, a printer, a scanner, a display device, and other such components. Other examples of input devices and output devices are described herein. In some embodiments, a communication interface device can be implemented as a complete and separate computing device.

In some embodiments, the computing device 1102 can be connected to one or more additional computing devices such as computing device 1124 via a network 1122 using a connection such as the network interface 1120. In such embodiments, the computing device 1124 may execute one or more services 1126 to perform one or more functions under the control of, or on behalf of, programs and/or services operating on computing device 1102. In some embodiments, a computing device such as computing device 1124 may include one or more of the types of components as described in connection with computing device 1102 including, but not limited to, a processor such as processor 1104, a connection such as connection 1106, a cache such as cache 1108, a storage device such as storage device 1110, memory such as memory 1114, an input device such as input device 1116, and an output device such as output device 1118. In such embodiments, the computing device 1124 can carry out the functions such as those described herein in connection with computing device 1102. In some embodiments, the computing device 1102 can be connected to a plurality of computing devices such as computing device 1124, each of which may also be connected to a plurality of computing devices such as computing device 1124. Such an embodiment may be referred to herein as a distributed computing environment.

The network 1122 can be any network including an internet, an intranet, an extranet, a cellular network, a Wi-Fi network, or any suitable network.

Communications over the network 1122, within the computing device 1102, within the computing device 1124, or within the computing resources provider 1128 can include information, which also may be referred to herein as content. The information may include text, graphics, audio, video, haptics, and/or any other information that can be provided to a user of the computing device such as the computing device 1102.

In some embodiments, the computing device 1102 and/or the computing device 1124 can be connected to a computing resources provider 1128 via the network 1122 using a network interface such as those described herein (e.g. network interface 1120). In such embodiments, one or more systems (e.g., service 1130 and service 1132) hosted within the computing resources provider 1128 (also referred to herein as within “a computing resources provider environment”) may execute one or more services to perform one or more functions under the control of, or on behalf of, programs and/or services operating on computing device 1102 and/or computing device 1124. Systems such as service 1130 and service 1132 may include one or more computing devices such as those described herein to execute computer code to perform the one or more functions under the control of, or on behalf of, programs and/or services operating on computing device 1102 and/or computing device 1124.

For example, the computing resources provider 1128 may provide a service, operating on service 1130 to store data for the computing device 1102 when, for example, the amount of data that the computing device 1102 exceeds the capacity of storage device 1110. In another example, the computing resources provider 1128 may provide a service to first instantiate a virtual machine (VM) on service 1132, use that VM to access the data stored on service 1132, perform one or more operations on that data, and provide a result of those one or more operations to the computing device 1102. Such operations (e.g., data storage and VM instantiation) may be referred to herein as operating “in the cloud,” “within a cloud computing environment,” or “within a hosted virtual machine environment,” and the computing resources provider 1128 may also be referred to herein as “the cloud.”

Services provided by a computing resources provider 1128 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1130 and service 1132 may implement versions of various services (e.g., the service 1112 or the service 1126) on behalf of, or under the control of, computing device 1102 and/or computing device 1124. Such implemented versions of various services may involve one or more virtualization techniques so that, for example, it may appear to a user of computing device 1102 that the service 1112 is executing on the computing device 1102 when the service is executing on, for example, service 1130. As may also be contemplated, the various services operating within the computing resources provider 1128 environment may be distributed among various systems within the environment as well as partially distributed onto computing device 1124 and/or computing device 1102.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}; a power set) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

Any patents and applications and other references noted above, including any that may be listed in accompanying filing papers, are incorporated herein by reference for all purposes. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving an instruction message for an automated agent to enter a processing state, wherein the instruction message is transmitted through a real-time chat interface by a user of a set of users;
analyzing the instruction message to detect that a task is to be performed, wherein analyzing the instruction message includes determining that performing the task requires additional information, and wherein determining includes classifying the automated agent in a standby state;
generating a survey message in the real-time chat interface to request additional information from the set of users;
processing responses from the set of users to the survey message in the real-time chat interface, wherein processing includes inputting the responses into a natural language processor to determine the additional information; and
adding a task message to the real-time chat interface, wherein adding the task message includes classifying the automated agent in the processing state, and wherein the method does not include a request from the set of users to perform the task using the additional information, thereby improving efficiency of the real-time chat interface.

2. The computer-implemented method of claim 1, wherein analyzing the instruction message includes processing the instruction message through a natural language processor to determine the task.

3. The computer-implemented method of claim 1, wherein analyzing the instruction message includes processing the instruction message through the real-time chat interface through a natural language processor to determine that additional information is required.

4. The computer-implemented method of claim 1, wherein receiving the instruction message includes processing conversation data through a machine learning model to determine the instruction message.

5. The computer-implemented method of claim 1, wherein classifying the automated agent in the standby state includes processing conversation data in a machine learning model.

6. The computer-implemented method of claim 1, wherein generating the survey message includes comparing a period of time elapsed from a message to a threshold time.

7. The computer-implemented method of claim 1, wherein generating the survey message includes processing messages from the set of users into a natural language processor to determine that the additional information has not been provided.

8. The computer-implemented method of claim 1, wherein the survey message includes suggestions for the additional information.

9. The computer-implemented method of claim 1, wherein the survey message is a question to the set of users.

10. The computer-implemented method of claim 1, further comprising adding a status message to the real-time chat interface, wherein the status message indicates the task to be performed.

11. The computer-implemented method of claim 1, further comprising performing the task.

12. The computer-implemented method of claim 1, wherein the instruction message includes a keyword.

13. The computer-implemented method of claim 1, further comprising:
receiving feedback from the set of users on the task message; and
updating the natural language processor using the feedback.

14. A system, comprising:
one or more processors; and
memory storing thereon instructions that, as a result of being executed by the one or more processors, cause the system to perform a method including:
receiving an instruction message for an automated agent to enter a processing state, wherein the instruction message is transmitted through a real-time chat interface by a user of a set of users;
analyzing the instruction message to detect that a task is to be performed, wherein analyzing the instruction message includes determining that performing the task requires additional information, and wherein determining includes classifying the automated agent in a standby state;
generating a survey message in the real-time chat interface to request additional information from the set of users;
processing responses from the set of users to the survey message in the real-time chat interface, wherein processing includes inputting the responses into a natural language processor to determine the additional information; and
adding a task message to the real-time chat interface, wherein adding the task message includes classifying the automated agent in the processing state, and wherein the method does not include a request from the set of users to perform the task using the additional information, thereby improving efficiency of the real-time chat interface.

15. The system of claim 14, wherein analyzing the instruction message includes processing the instruction message through a natural language processor to determine the task.

16. The system of claim 14, wherein analyzing the instruction message includes processing the instruction message through the real-time chat interface through a natural language processor to determine that the additional information is required.

17. The system of claim 14, wherein classifying the automated agent in a standby state includes processing conversation data into a set of embeddings.

18. A non-transitory computer-readable storage medium storing thereon executable instructions that, as a result of being executed by one or more processors of a computer system, cause the computer system to perform a method comprising:
receiving an instruction message for an automated agent to enter a processing state, wherein the instruction message is transmitted through a real-time chat interface by a user of a set of users;
analyzing the instruction message to detect that a task is to be performed, wherein analyzing the instruction message includes determining that performing the task requires additional information, and wherein determining includes classifying the automated agent in a standby state;
generating a survey message in the real-time chat interface to request additional information from the set of users;
processing responses from the set of users to the survey message in the real-time chat interface, wherein processing includes inputting the responses into a natural language processor to determine the additional information; and
adding a task message to the real-time chat interface, wherein adding the task message includes classifying the automated agent in the processing state, and wherein the method does not include a request from the set of users to perform the task using the additional information, thereby improving efficiency of the real-time chat interface.

19. The non-transitory computer-readable storage medium of claim 18, wherein analyzing the instruction message includes processing the instruction message through a natural language processor to determine the task.

20. The non-transitory computer-readable storage medium of claim 18, wherein analyzing the instruction message includes processing the instruction message through the real-time chat interface through a natural language processor to determine that the additional information is required.
